(19) United States
(12) Patent Application Publication
(10) Pub. No.: US 2007/0245580 A1
(43) Pub. Date: Oct. 25, 2007

(54) TWO AXIS LEVEL

(76) Inventor: David Jelinek, Rhinelander, WI (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/379,881

(22) Filed: Apr. 24, 2006

(51) Int. Cl. G01C 9/00

(52) U.S. Cl. 33/372

(57) ABSTRACT

Apparatus for measuring the verticality of a structural element uses two mutually perpendicular level indicators to determine the orientation of a plane with respect to level with a single observation. The indicators are mounted within a base which can have a recess along one side perpendicular to both level indicators. Placing the recess against the element to be measured at a predetermined location automatically aligns the observed plane with respect to the element. A spring loaded clamp can also be employed. The clamp can be separate or can be permanently attached to the base. The clamp engages the structural element and secures the apparatus to the element. One of the indicators can be pivoted from a first stored location within the base to a second orientation extending outward during observation to provide storage protection for the indicator.

### BACKGROUND OF THE INVENTION

1. Field of the Invention

This invention provides apparatus to establish the orientation of vertical structures with respect to a horizontal plane to assist in their vertical installation using a single observation.

2. Description of the Related Art

Installation of vertical elements often requires that some of the elements have a vertical orientation to conform to other elements of a structure. To establish vertical orientation two separate horizontal axis measurement are currently required. A common example is the installation of a vertical pipe. This will be described as an example although the same apparatus can be used with only minor modifications on any structural element which must be installed in a vertical orientation. Establishing vertical orientation of a pipe is presently accomplished by using a bubble level to establish each axis separately. Quite often after the first axis is measured, measuring the second axis will change the orientation of the element with respect to the first axis. This results either in an incorrect orientation of the element or repeated measurements of the two separate axes by a single level indicator to obtain the correct orientation. It would be desirable if two axes could be observed simultaneously with respect to horizontal to eliminate this problem.

### SUMMARY OF THE INVENTION

A level with two level indicators is provided. The indicators are mounted within a base perpendicular to each other, The perpendicularity of the first and second bubble level indicators provides a means for simultaneously observing whether a plane, perpendicular to a particular element in a structure, is horizontal. The first level indicator can be mounted in a convention manner in the base of the level, while the second level indicator can be arranged to be rotated outward from the body of the level to an orientation perpendicular to the first bubble indicator to provide the same planar capability. This arrangement minimizes the possibility of damage to the outwardly extending indicator, since it can be stored within the body of the level except during observation.

To facilitate alignment of the level with respect to the structure to be measured, the base can have a groove extending along its length sized to mate with part of a vertical portion of the side of an element whose verticality is to be measured. As mentioned earlier, quite often this element is a pipe, which will be used in the following discussion. The groove is a recess which is shaped and sized to mate with at least a portion of an outer surface of the pipe to be oriented vertically. With this arrangement placing the groove against the pipe will provide a predetermined orientation of the base with respect to the pipe. Here the level indicators are arranged to measure the horizontal orientation of a plane when the base has the predetermined orientation with respect to the selected portion of the pipe. Here, with the pipe oriented parallel to the recess, a horizontal orientation of both of the indicators will result in a vertical orientation of the pipe. The base can have a clamp arranged to clamp the base against the pipe to eliminate the necessity of the user holding the level against the element while making a level observation. The clamp can be either a portion of the apparatus or can be temporarily attached when a measurement is to be made. If desired, without providing a clamp it is feasible to simply place the apparatus against the structure with the groove enclosing a predetermined portion of the structure, and hold the apparatus in place while making the observation.

### BRIEF DESCRIPTION OF THE DRAWINGS

The objects and features of the present invention will become more manifest to those skilled in the art upon a reading of the following descriptions, taken in conjunction with the accompanying drawings and wherein:

FIG. 1 shows an isometric view of the two axis level attached to a vertical element, in this case a pipe, with a pivotable one of the bubble level indicators stored in the base; and

FIG. 2 shows an isometric view of the two axis level attached to a pipe with the pivotable one of the bubble level indicators deployed outward in a position to measure one of the level axes.

### DETAILED DESCRIPTION OF THE INVENTION

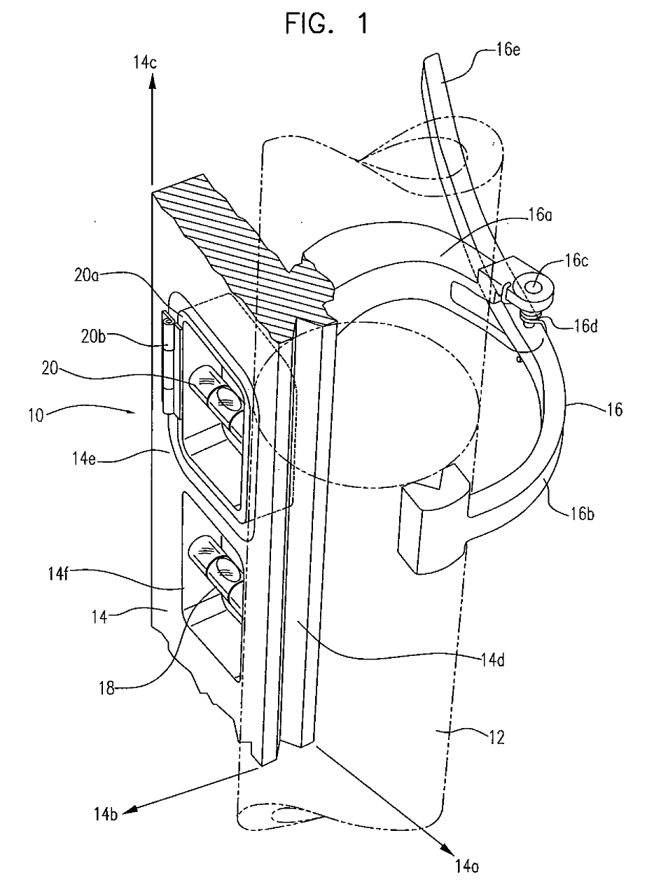

FIG. 1 shows two axis plumbers level 10 attached to an essentially vertical element, here pipe 12. Base 14 is block shaped with opposed parallel sides mutually perpendicular to the other sides having axes 14a, 14b and 14c, as shown, which are aligned with one of the three mutually perpendicular sides. Linear concave recess 14d extending along one side of base 14 is aligned with axis 14c. Recess 14d is concave in shape and arranged to mate with at least the portion of the side of pipe 12, which is to be oriented vertically. With this arrangement placing recess 14d against pipe 12 will align axis 14a of base 14 with pipe 12. This results in horizontal axes 14a and 14b being in a plane which is perpendicular to pipe 12. As described later, the horizontal measurements are taken along axes 14a and 14b. With this arrangement locating level 10 correctly to measure a plane perpendicular to the pipe merely requires placing recess 14d of base 14 against pipe 12.

Base 14 can be held in place against pipe 12 with recess 14d adjacent to pipe 12 either simply by hand or by spring loaded clamp 16. Clamp 16 has a first part 16a and a second part 16b. First part 16a is attached to base 14. Pin 16c extending through mating holes in first part 16a and second part 16b of clamp 16 provides pivoting freedom between the parts. A spring 16d is arranged to secure parts 16a and 16b together and also to urge the inner sides of the outer ends of first part 16a and second part 16b together to partially encircle pipe 12 and securely hold base 14 against the pipe. Second part 16b includes a handle 16e extending outwardly opposite to first part 16a. Handle 16e provides leverage to separate the ends of first part 16a and second part 16b of clamp 16 for attaching or removing base 14 and pipe 12.

Base 14 has rectangular shaped openings 14e and 14f extending along axis 14b through the base. First level indicator 18 is mounted within opening 14f and is aligned with axis 14a to measure the orientation of this axis with respect to level, arranged such that the indicator can be read from either side of the indicator.

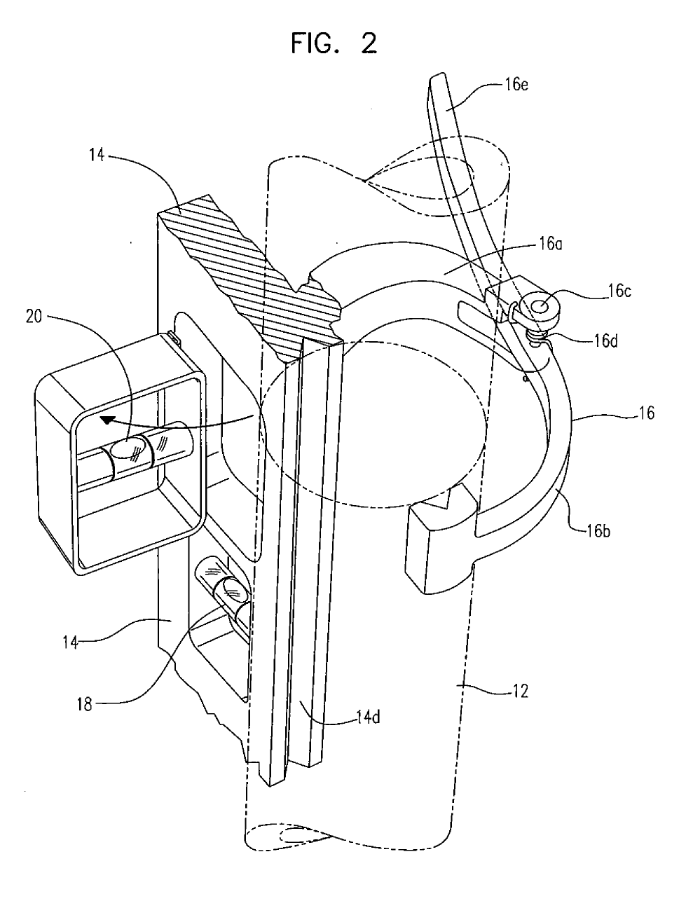

Second level indicator 20 is mounted within pivoting apparatus, which consists of a frame 20a and a pivot 20b, with the indicator positioned within the frame. Pivot 20b provides pivoting freedom between frame 20 and opening 14e in base 14. As shown in FIG. 1, indicator 20 is also aligned with axis 14a, however this orientation is used only for storage of the indicator. FIG. 2 shows the same apparatus but here indicator 20 has been pivoted outward 90 degrees from the previous orientation and is now aligned to measure along axis 14b. With this arrangement indicator 20 can now determine the horizontal orientation of axis 14b and can also be read from either side. Indicators 18 and 20 must be perpendicular to each other and mutually perpendicular to axis 14c in order to determine the verticality of axis 14c. Axis 14c is also the orientation of pipe 12 when recess 14d is positioned adjacent to the pipe. Because of this mutual perpendicularity requirement, this ability to pivot indicator 20 permits storing the indicator within base 14 to provide additional protection rather than having it extend outward from the base in a location more likely to result in damage.

This apparatus provides a simple way to determine the orientation of a pipe's verticality. As discussed earlier, it is presently necessary to make two separate and independent measurements to determine the orientation of a pipe with respect to two horizontal axes. This is subject to error and requires additional time to accomplish. Here the apparatus is simply placed adjacent to the pipe by hand, or it can be clamped to the pipe by a spring loaded clamp, such that the concave shaped recess is adjacent to the pipe. This provides proper orientation for a simultaneous two axis observation of the vertical orientation of the pipe. The ability to pivot one of the indicators into the base reduces its chances of injury during storage, and the fact that both indicators can be read from either side simplifies a simultaneous observation. The simplicity of use and the ability to make a simultaneous observation of a plane perpendicular to an element improves the accuracy and reduces the time required to perform the task. As described, the clamp need not be a permanent part of the apparatus, and the observation can also be made by simply holding the apparatus against the pipe while making an observation.

While the discussion is directed to a pipe because of the common requirement to orient some of the pipes vertically within a structure, this apparatus is not limited to pipes. A large number of structural elements require vertical orientation in order to operate properly or to look appropriate within a structure. Using this apparatus with other structural elements merely requires locating an element which should be vertical, and aligning the appropriate axis of the level with this element using an appropriately shaped recess arranged to mate with a predetermined portion of the element. An appropriately sized and shaped recess and an optional clamp, which need not be a permanent part of the apparatus, can be adapted to a variety of structural elements to provide the same assistance in determining their vertical orientation the same as that described for orientating a pipe vertically.

While only one embodiment of this apparatus has been described in detail, there are numerous modifications and changes that are possible for other structural elements, and would readily occur to one skilled in the art. While a bubble level has been described here, this is not the only kind of level that could be used, essentially any level that will permit determining the relationship of two axis of the level with respect to horizontal will suffice.

Changes may be made in details, particularly in matters of shape, size, material, and arrangement of parts without exceeding the scope of the invention. It should be understood therefore that this disclosure, in many respects, is only illustrative. Therefore it is contemplated that the appended claims will cover any such modifications or embodiments that fall within the true scope of the invention. Accordingly, the scope of the invention is as defined in the language of the appended claims.

What is claimed is:

1. Apparatus for measuring a plane comprising:
a) a base having mutually perpendicular first, second and third axes;
b) first and second level indicators with the level indicators being attached to the base in orientations resulting in the first level indicator indicating the orientation of the first axis of the base with respect to level, and the second level indicator indicating the orientation of the second axis of the base with respect to level; and
c) alignment means for aligning the third axis of the base with respect to a predetermined orientation of a structural element.

2. Apparatus as in claim 1 further comprising attachment means for attaching the base to said structural element in said predetermined orientation.

3. Apparatus as in claim 1 wherein the means for aligning the third axis of the base with respect to a predetermined orientation of a structural element comprises the base having a concave linear outer recess which is parallel to the third axis, the recess being sized, shaped and oriented to engage the predetermined portion of the element and thus orient the third axis of the base parallel with said predetermined portion.

4. Apparatus as in claim 3 having clamping means for maintaining the engagement of the recess of the base with the predetermined portion of the element.

5. Apparatus as in claim 4 wherein the element is a pipe and the has a concave recess extending linearly along one surface, the apparatus clamping means further comprising spring means for maintaining the engagement of recess with the predetermined portion of the element.

6. Apparatus as in claim 5 wherein:
a) said clamping means is attached to said base and comprises a clamp having arcuate first and second clamp parts pivotably connected together, said parts being sized and arranged to engage and enclose at least a portion of a pipe, the end of the first part being opposite the connection to the second part, with both being connected to the base such that the clamp can enclose a pipe with the recess adjacent and parallel to the pipe, and with the second part having an attached handle extending outwardly in a direction opposite to the first part arranged to permit pivoting the second part with respect to the first part to attach and remove the base from the pipe; and
b) said spring means comprising a spring arranged to hold the first and second parts together and urge the inner side of the outer ends of the parts together to maintain engagement of the base with a pipe.

7. Apparatus as in claim 1 wherein the base has first and second openings extending along the second axis through the base, the first and second openings being sized and arranged to respectively enclose and display the first and second level indicators, the indicators being aligned with respect to the base such that the first level indicator measures the orientation of the first axis of the base with respect to level, with the second level indicator having pivot means for pivoting the second level indicator about an axis aligned with the third axis of the base near one end of the second indicator, from a first orientation where the second level indicator is stored within the second opening, to a second orientation where the second level indicator can measure the orientation of the second axis of the base with respect to level.
